(19) United States
(12) Patent Application Publication
(10) Pub. No.: US 2019/0080360 A1
(43) Pub. Date: Mar. 14, 2019

(54) TECHNOLOGIES FOR PROPOGATING ADVERTISEMENTS

(71) Applicant: INTEL CORPORATION, Santa Clara, CA (US)

(72) Inventors: Xiaoyong PAN, Shanghai (CN); Justin LIPMAN, Shanghai (CN)

(21) Appl. No.: 16/084,481

(22) PCT Filed: Apr. 1, 2016
(86) PCT No.: PCT/CN2016/078297

§ 371 Date: Sep. 12, 2018

(51) Int. Cl. G06Q 30/02

(52) U.S. Cl. CPC G06Q 30/0274; G06Q 30/0214; G06Q 30/0277

(57) ABSTRACT

Technologies for propagating advertisements include an advertisement management server (102). The advertisement management server (102) includes a memory (204) to store advertisement data (302) and an advertisement data creation module (330) to generate a first registration of an advertisement in the advertisement data (302), wherein the first registration is associated with a first advertiser and generate a second registration of the advertisement in the advertisement data (302), wherein the second registration is based on the first registration and is associated with a second advertiser that is different from the first advertiser. The advertisement management server (102) also includes a compensation manager module (340) to detect an interest event associated with the second registration of the advertisement, determine a first amount of compensation to assign to the first advertiser based on the interest event, and determine a second amount of compensation to assign to the second advertiser based on the interest event.

### BACKGROUND

Merchants spend a relatively large amount of money to promote their brand and products every year. Internet and social networking platforms are major online channels for merchants to deliver brand and product messages (e.g., advertisements) to customers and end users. Merchants may deliver the advertisements through merchant-owned accounts or through third party accounts (i.e., advertisers), such as famous bloggers or other people who have a following in an online community.

The third party advertisers are generally willing to post advertisements on behalf of the merchants because the merchants may provide incentives to the advertisers based on user actions resulting from the advertisements, according to agreements between the advertisers and the merchants. However, the propagation of an advertisement may be stopped at the people who follow these advertisers, because there are no incentives for those followers to forward or re-post the advertisements for their followers to view.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for electronically propagating advertisements among compute devices;

FIG. 2 is a simplified block diagram of at least one embodiment of an advertisement management server of the system of FIG. 1;

FIG. 3 is a simplified block diagram of at least one embodiment of an environment that may be established by the advertisement management server of FIGS. 1 and 2;

FIGS. 4-6 are a simplified flow diagram of at least one embodiment of a method for registering an advertisement that may be performed by the advertisement management server of FIGS. 1 and 2;

FIGS. 7-8 are a simplified flow diagram of at least one embodiment of a method for assigning compensation to advertisers in response to an interest event for an advertisement that may be performed by the advertisement management server of FIGS. 1 and 2; and

FIG. 9 is a simplified block diagram of advertisement data maintained by the advertisement management server of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

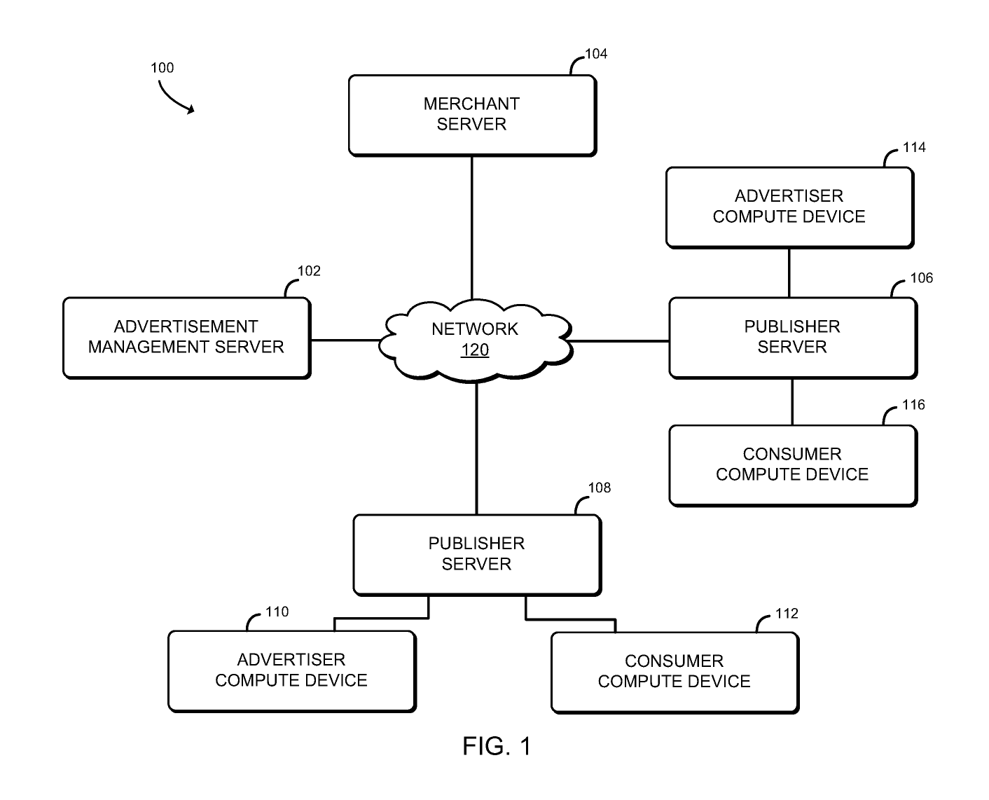

Referring now to FIG. 1, in an illustrative embodiment, a system 100 for propagating advertisements includes an advertisement management server 102, a merchant server 104, publisher servers 106, 108, advertiser compute devices 110, 114, and consumer compute devices 112, 116 in communication through a network 120. In operation, the illustrative advertisement management server 102 is configured to register merchants, advertisers, and advertisements in a database, track interest events (i.e., actions indicative of a person's interest in the advertisement) associated with the registered advertisements, and manage the determination and distribution of compensation from one or more of the merchants to one or more of the advertisers, in response to the interest events. Importantly, compensation may be distributed not just to a single level of advertisers who may have negotiated directly with a merchant, but rather may flow to additional levels of advertisers who may re-post advertisements and who may not have negotiated directly with the merchants. By enabling a multi-tiered advertisement propagation system that rewards subsequent levels of advertisers who re-post advertisements, the advertisement management server 102 increases the amount of potential customers a merchant can reach with its advertisements.

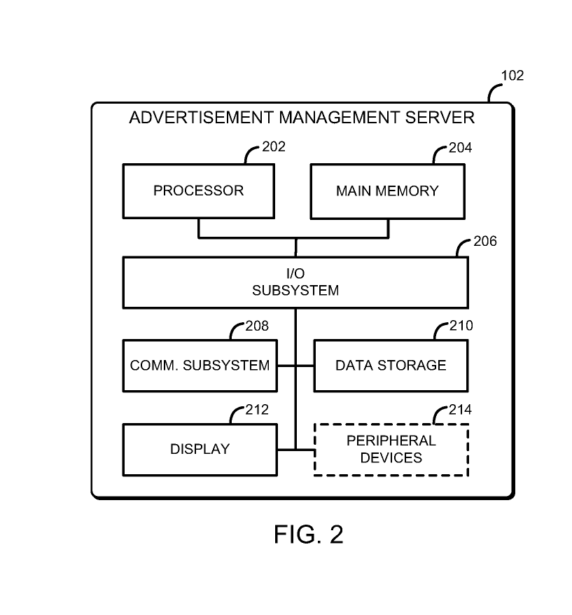

Referring now to FIG. 2, the advertisement management server 102 may be embodied as any type of compute device capable of performing the functions described herein. For example, in some embodiments, the advertisement management server 102 may be embodied as, without limitation, a server computer, a distributed computing system, a multiprocessor system, a consumer electronic device, a smart appliance, and/or any other computing device capable of performing the functions described herein. Although shown as a single compute device, it should be appreciated that the advertisement management server 102 may be embodied as a collection of servers and/or other compute devices configured to cooperate to perform the functions described herein. As shown in FIG. 2, the illustrative advertisement management server 102 includes a processor 202, a main memory 204, an input/output subsystem 206, and a communication subsystem 208. Of course, the advertisement management server 102 may include other or additional components, such as those commonly found in a server compute device (e.g., various input/output devices, data storage device(s), etc.), in other embodiments. Additionally, in some embodiments, one or more of the illustrative components may be incorporated in, or otherwise from a portion of, another component. For example, the main memory 204, or portions thereof, may be incorporated in the processor 202 in some embodiments.

The processor 202 may be embodied as any type of processor capable of performing the functions described herein. For example, the processor may be embodied as a single or multi-core processor(s) having one or more processor cores, a digital signal processor, a microcontroller, or other processor or processing/controlling circuit. Similarly, the main memory 204 may be embodied as any type of volatile or non-volatile memory or data storage capable of performing the functions described herein. In operation, the main memory 204 may store various data and software used during operation of the advertisement management server 102 such as advertisement data, merchant data, advertiser data, operating systems, applications, programs, libraries, and drivers. The main memory 204 is communicatively coupled to the processor 202 via the I/O subsystem 206.

The I/O subsystem 206 may be embodied as circuitry and/or components to facilitate input/output operations with the processor 202, the main memory 204, and other components of the advertisement management server 102. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the advertisement management server 102, on a single integrated circuit chip.

The advertisement management server 102 additionally includes the communication subsystem 208. The communication subsystem 208 may be embodied as one or more devices and/or circuitry for enabling communications with one or more other compute devices over a network (e.g., the network 120 of FIG. 1). The communication subsystem 208 may be configured to use any one or more communication technology (e.g., wired or wireless communications) and associated protocols (e.g., Ethernet, Bluetooth®, Wi-Fi®, WiMAX, etc.) to effect such communication.

The advertisement management server 102 may additionally include a data storage device 210 which may be embodied as any type of device or devices configured for short-term or long-term storage of data such as, for example, memory devices and circuits, memory cards, hard disk drives, solid-state drives, or other data storage devices. The data storage device 210 may store advertisement data, merchant data, advertiser data, operating systems, applications, programs, libraries, and/or drivers, as described in more detail herein.

The advertisement management server 102 may also include a display device 212 on which information may be displayed to a user of the advertisement management server 102. The display device 212 may be embodied as, or otherwise use, any suitable display technology including, for example, a liquid crystal display (LCD), a light emitting diode (LED) display, a cathode ray tube (CRT) display, a plasma display, and/or other display usable in a compute device. The display device 212 may include a touchscreen sensor that uses any suitable touchscreen input technology to detect the user's tactile selection of information displayed on the display including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

The advertisement management server 102 may additionally include one or more peripheral devices 214. Such peripheral devices 214 may include any type of peripheral device commonly found in a compute device such as speakers, a mouse, a keyboard, and/or other input/output devices, interface devices, and/or other peripheral devices.

Referring back to FIG. 1, the merchant server 104 may be embodied as any type of compute device capable of registering a merchant with the advertisement management server 102, providing advertisements to be registered with the advertisement management server 102 for posting by the advertisers, and providing an ability to purchase products sold by the merchant, such as in response to a user selecting an advertisement for one of the products. Each publisher server 106, 108 may be embodied as any type of compute device capable of transmitting content (e.g., web pages, videos, or other media) that includes advertisements to the consumer compute devices 112, 116. Accordingly, each illustrative publisher server 106, 108 is capable of embedding or otherwise including advertisements posted by the advertisers in the content transmitted by the publisher servers 106, 108. As described in more detail herein, the advertisements are associated with identifiers, such as uniform resource locators (URLs), that redirect a consumer to the merchant server 104 to view more information about an advertised product and enable a consumer to purchase the product. Further, the advertisements include an identifier associated with corresponding advertisement registration data maintained by the advertisement management server 102 to enable the advertisement management server 102 to identify which advertiser was responsible for posting the advertisement, which merchant is associated with the advertisement, compensation information associated with the registered advertisement, and other information.

Each advertiser compute device 110, 114 is configured to enable an advertiser to register with the advertisement management server 102, register an advertisement with the advertisement management server 102, and post advertisements to one or more of the publisher servers. Further, each consumer compute device 112, 116 is configured to enable a consumer to view content, including advertisements, transmitted by the publisher servers 106, 108, select (e.g., click on) the advertisements to view more information about an advertised product, purchase the product, or re-post the advertisement, in which case the consumer becomes an advertiser and the consumer compute device 112, 116, operates as an advertiser compute device. The merchant server 104, the publisher servers 106, 108, the advertiser compute devices 110, 114, and the consumer compute devices 112, 116 may include components commonly found in a compute device, such as a processor, memory, I/O subsystem, data storage, communication subsystem, etc. Those components may be substantially similar to the corresponding components of the advertisement management server 102. As such, further descriptions of the like components are not repeated herein with the understanding that the description of the corresponding components provided above in regard to the advertisement management server 102 applies equally to the corresponding components of the merchant server 104, the publisher servers 106, 108, the advertiser compute devices 110, 114, and the consumer compute devices 112, 116.

As described above, the compute devices of the system 100 are illustratively in communication via the network 120, which may be embodied as any number of various wired or wireless networks. For example, the network 120 may be embodied as, or otherwise include, a wired or wireless local area network (LAN), a wired or wireless wide area network (WAN), a cellular network, and/or a publicly-accessible, global network such as the Internet. As such, the network 120 may include any number of additional devices, such as additional computers, routers, and switches, to facilitate communications among the devices of the system 100.

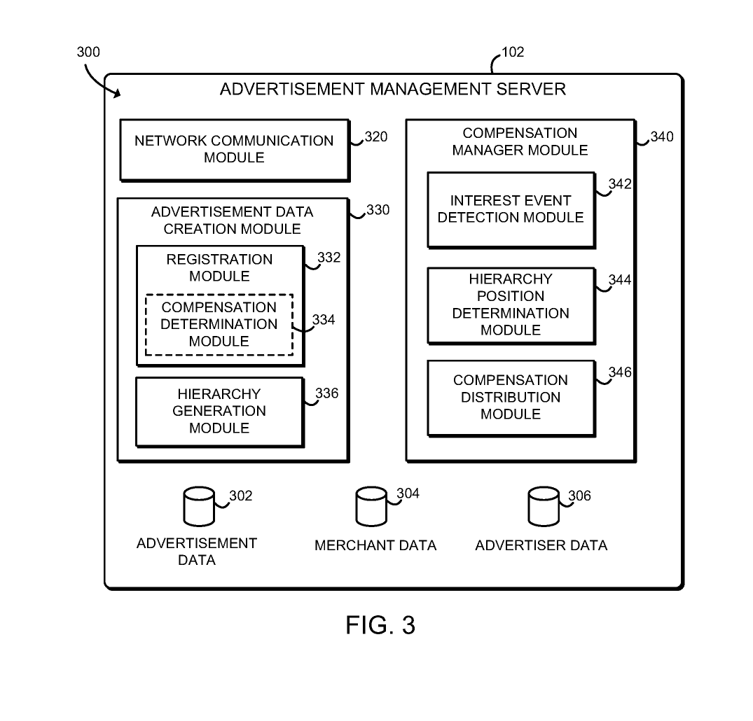

Referring now to FIG. 3, in the illustrative embodiment, the advertisement management server 102 establishes an environment 300 during operation. The illustrative environment 300 includes a network communication module 320, an advertisement data creation module 330, and a compensation manager module 340. Each of the modules, logic, and other components of the environment 300 may be embodied as hardware, firmware, software, or a combination thereof. As such, in some embodiments, one or more of the modules of the environment 300 may be embodied as circuitry or collection of electrical devices (e.g., network communication circuitry 320, advertisement data creation circuitry 330, compensation manager circuitry 340, etc.). It should be appreciated that, in such embodiments, one or more of the network communication circuitry 320, advertisement data creation circuitry 330, and compensation manager circuitry 340 may form a portion of one or more of the processor 202, main memory 204, I/O subsystem 206, and/or other components of the advertisement management server 102. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the advertisement management server 102.

In the illustrative environment 300, the advertisement management server 102 includes advertisement data 302 that includes identifiers of advertisements registered with the advertisement management server 102, relationships between registrations of an advertisement, compensation amounts to be assigned to advertisers based various types of interest events (i.e., actions indicative of a person's interest in the advertisement), that may occur in association with each advertisement (e.g., views, selections, purchases, re-postings), and other information. The illustrative environment 300 additionally includes merchant data 304 that includes information regarding each merchant associated with the advertisements represented in the advertisement data 302. The illustrative merchant data 304 includes identifiers, names, financial account information, contact information, and other information regarding each merchant. Further, the illustrative environment 300 includes advertiser data 306 which includes identifiers, names, financial account information, and contact information for each advertiser associated with a registration of an advertisement in the advertisement data 302. The advertisement data 302, the merchant data 304, and the advertiser data 306 may be accessed by the various modules and/or sub-modules of the advertisement management server 102. It should be appreciated that the advertisement management server 102 may include other components, sub-components, modules, sub-modules, and/or devices commonly found in a compute device, which are not illustrated in FIG. 3 for clarity of the description.

The network communication module 320, which may be embodied as hardware, firmware, software, virtualized hardware, emulated architecture, and/or a combination thereof as discussed above, is configured to manage inbound and outbound network communications to and from the advertisement management server 102, respectively. For example, the network communication module 320 is configured to receive registration requests and registration data for advertisements, merchants associated with the advertisements, and advertisers who may post the advertisements. Further, the network communication module 320 is illustratively configured to receive data indicative of interest events associated with registered advertisements. For example, a registered advertisement may include code (e.g., JavaScript) to cause a consumer compute device to transmit data pertaining to a consumer's viewing time of an advertisement (i.e., amount of time that the advertisement was displayed on a consumer compute device 112, 116) to the network communication module 320 of the advertisement management server 102. Similarly, the network communication module 320 may receive data indicative of a selection (i.e., a click-through) of the registered advertisement on a consumer compute device 112, 116, such as a URL that initially directs the consumer compute device to the advertisement management server 102 which may then redirect the consumer compute device to the merchant server 104.

Additionally, the network communication module 320 may receive data indicative of a purchase of a product associated with one of the registered advertisements. For example, the merchant server 104 may transmit such data if the consumer discussed above purchases an advertised product through the merchant server 104, after being redirected to the merchant server 104 by the advertisement management server 102. Additionally, the network communication module 320 may receive data indicative of an advertiser re-posting an advertisement. In the illustrative embodiment, a re-posting process may begin when a potential advertiser visits the advertisement management server 102 and identifies an advertisement to re-post, or is redirected to the advertisement management server 102 in response to selecting a “re-post” or “re-advertise” link on a registered advertisement. As described in more detail, the advertisement management server 102 may generate a new registration of the advertisement and transmit identification code to the potential advertiser to be used in association with the advertisement, to enable interest events to be associated with that registration of the advertisement, as described in more detail herein. Additionally, the network communication module 320 may transmit data to facilitate distribution of compensation to various advertisers in connection with detected interest events.

The advertisement data creation module 330, which may be embodied as hardware, firmware, software, virtualized hardware, emulated architecture, and/or a combination thereof as discussed above, is configured to manage registration of advertisements. As described in more detail herein, to register an advertisement, the advertisement management server 102 may also register merchants and/or advertisers associated with the advertisements to be registered. Further, in registering the advertisements, the advertisement data creation module 330 may generate hierarchies of registrations to enable multiple advertisers associated with an advertisement to be compensated in response to detected interest events. To perform these functions, the illustrative advertisement data creation module 330 includes a registration module 332 and a hierarchy generation module 336.

The illustrative registration module 332 is configured to receive information associated with an advertisement and generate a corresponding advertisement registration in the advertisement data 302. An advertisement registration illustratively includes an identifier of the advertisement, an identifier of a merchant associated with the advertisement, and an identifier of an advertiser who is to post the advertisement on one or more of the publisher servers 106, 108. Accordingly, the registration module 332 is additionally configured to receive information regarding the merchants and advertisers, including names, financial account information, and contact information and generate corresponding merchant registrations and advertiser registrations in the merchant data 304 and the advertiser data 306, respectively. Additionally, the illustrative registration module 332 includes a compensation determination module 334 configured to receive information that indicates the amount and types of compensation to be assigned to advertisers in response to detection of interest events. For example, the compensation determination module 334 may receive information during the registration of an advertisement that the total compensation to be paid by the merchant when a customer purchases a product based on a registered advertisement is ten dollars. The compensation determination module 334 may additionally receive information specifying that the merchant is to pay one dollar each time the registered advertisement is viewed by a consumer. Further, the compensation determination module 334 may receive information specifying other amounts of compensation for other types of interest events, such as selections (e.g., click-throughs) and re-postings of the registered advertisement. Further, the compensation determination module 334 may receive information specifying the type of compensation, such as dollars, another type of currency, points redeemable by the merchant, products, or other incentives. Further, the compensation determination module 334 may receive information that specifies an amount of the compensation to be assigned to an advertiser who has re-posted the advertisement, wherein the interest event occurred based on that re-posted version of the advertisement (i.e., a consumer clicks on the re-posted advertisement at the publisher server 108, rather than an original posting of the advertisement at the publisher server 106).

The illustrative hierarchy generation module 336 is configured to generate subsequent registrations based on an original advertisement registration, wherein each subsequent registration is associated with a different advertiser. For example, a first advertiser may initially register advertisement A. Subsequently, a second advertiser may contact the advertisement management server 102 with the intent to re-post the advertisement. The hierarchy generation module uses a second registration of advertisement A, generated by the registration module 332, and links it to the first registration of advertisement A. The second registration of advertisement is considered a “child” of the first registration of advertisement A. Yet another advertiser may see advertisement A, posted by the second advertiser, for example on the publisher server 106, and contact the advertisement management server 102 to create a third registration of advertisement A, to be associated with the third advertiser. Accordingly, the hierarchy generation module 336 may be configured to link a third registration of advertisement A to the second registration of advertisement A. In other words, the third registration is a child of the second registration. By creating the linked registrations, the hierarchy generation module 336 may generate a hierarchy that describes the relationships between the various registrations of advertisements.

It should be appreciated that each of the registration module 332, the compensation determination module 334, and the hierarchy generation module 336 of the advertisement data creation module 330 may be separately embodied as hardware, firmware, software, virtualized hardware, emulated architecture, and/or a combination thereof. For example, the registration module 332 may be embodied as a hardware component, while the compensation determination module 334 and the hierarchy generation module 336 are embodied as a virtualized hardware components or as some other combination of hardware, firmware, software, virtualized hardware, emulated architecture, and/or a combination thereof.

The compensation manager module 340, which may be embodied as hardware, firmware, software, virtualized hardware, emulated architecture, and/or a combination thereof as discussed above, is configured to detect an occurrence of an interest event for a registered advertisement, determine compensation amounts to be distributed to various advertisers associated with the registered advertisement, and manage distribution of the compensation. To do so, the compensation manager module 340 illustratively includes an interest event detection module 342, a hierarchy position determination module 344, and a compensation distribution module 346. The interest event detection module 342 is configured to analyze data received by the network communication module 320 to determine whether one or more interest events have occurred for a registered advertisement. In the illustrative embodiment, the data received by the network communication module 320 that indicates such interest events includes an identifier of the particular registration of the advertisement that the interest event occurred in connection with (i.e., the redirect URL associated with the advertisement posted by the second advertiser includes an identifier detected by the interest event detection module 342 that identifies the second registration of advertisement A).

The illustrative hierarchy position determination module 344 is configured determine a position in the hierarchy generated by the hierarchy generation module 336 of the advertisement registration associated with a detected interest event. For example, the hierarchy position determination module 344 may determine that the interest event was associated with the second registration of advertisement A. The compensation manager module 340 may be configured to determine, based on the data stored by the compensation determination module 334, that the second advertiser (i.e., the advertiser associated with the second registration) is to receive 90% of the total compensation for the interest event and that the first advertiser, associated with the parent registration of advertisement A (i.e., the first registration) is to receive 10% of the total compensation. The illustrative compensation distribution module 346 is configured to coordinate distribution of the compensation to the appropriate advertisers based on the detected interest event, the determined position in the hierarchy, the compensation data stored by the compensation determination module 334, and the financial account data of the merchant (i.e., located in the merchant data 304) and the advertisers (i.e., located in the advertiser data 306). For example, the illustrative compensation distribution module 346 may receive money from a bank account associated with the merchant and transmit appropriate portions of the money to the respective advertisers. In some embodiments, the compensation distribution module 346 may further be configured to retain a portion of the compensation in a bank account associated with an owner or operator of the advertisement management server 102.

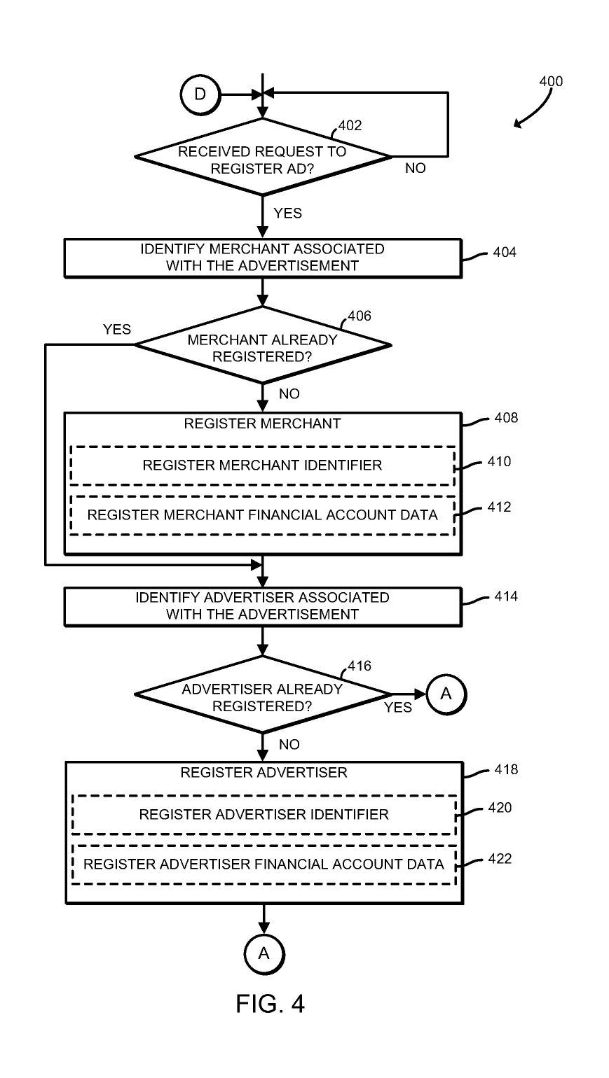

Referring now to FIG. 4, in use, the advertisement management server 102 may execute a method 400 for registering an advertisement. The method 400 begins with block 402, in which the advertisement management server 102 determines whether a request to register an advertisement has been received. The advertisement management server 102 may receive the request from a merchant associated with the advertisement (i.e., from the merchant server 104) or from an advertiser (i.e., from one of the advertiser compute devices 110, 114) who wishes to post or re-post the advertisement. In some embodiments, the advertisement management server 102 may receive the request from another source. Regardless, if the advertisement management server 102 determines that it has received a request to register an advertisement, the method 400 advances to block 404 in which the advertisement management server 102 identifies the merchant associated with the advertisement. For example, the advertisement management server 102 may receive an identifier of the merchant, such as an identification code, a name, or other information to uniquely identify the merchant. In block 406, the advertisement management server 102 determines whether the merchant identified in block 404 has been registered with the advertisement management server 102. For example, the illustrative advertisement management server 102 searches the merchant data 304 to determine whether an entry corresponding to the identified merchant is stored therein. If the merchant is not already registered, the method 400 advances to block 408 in which the advertisement management server 102 registers the merchant. In doing so, the advertisement management server 102 may register (i.e., receive and store) a merchant identifier. The illustrative merchant identifier uniquely identifies the merchant from other merchants and may be embodied as an identification code, a name, contact information, and/or other identifying information.

Additionally, as indicated in block 412, the illustrative advertisement management server 102 also registers merchant financial account data, which may be embodied as a bank name, routing number, account number, and/or other information to facilitate transfers of money or other forms of compensation (e.g., points) from a financial account of the merchant. Subsequently, or if the advertisement management server 102 determined, in block 406, that the merchant associated with the advertisement is already registered, the method 400 advances to block 414, in which the advertisement management server 102 identifies an advertiser associated with the present registration of the advertisement. As described in more detail herein, a given advertisement may have multiple registrations, each associated with a different advertiser. The advertisement management server 102 may receive an identification code, a name, or other information usable to identify an advertiser in the advertiser data 306. If the advertisement management server 102 determines that the advertiser is not already registered (i.e., not already represented in the advertiser data 306), the method 400 advances to block 418 to register the advertiser associated with the present advertisement registration. In doing so, the illustrative advertisement management server 102 registers (i.e., receives and stores) an advertiser identifier, as indicated in block 420. The advertiser identifier uniquely identifies the advertiser and may be embodied as an identification code, a name, contact information, and/or other identifying information. Additionally, in the illustrative embodiment, the advertisement management server 102 additionally registers advertiser financial account data, as indicated in block 422. The advertiser financial account data may be embodied as a bank name, routing number, account number, and/or other information to facilitate transfers of money or other compensation to the advertiser.

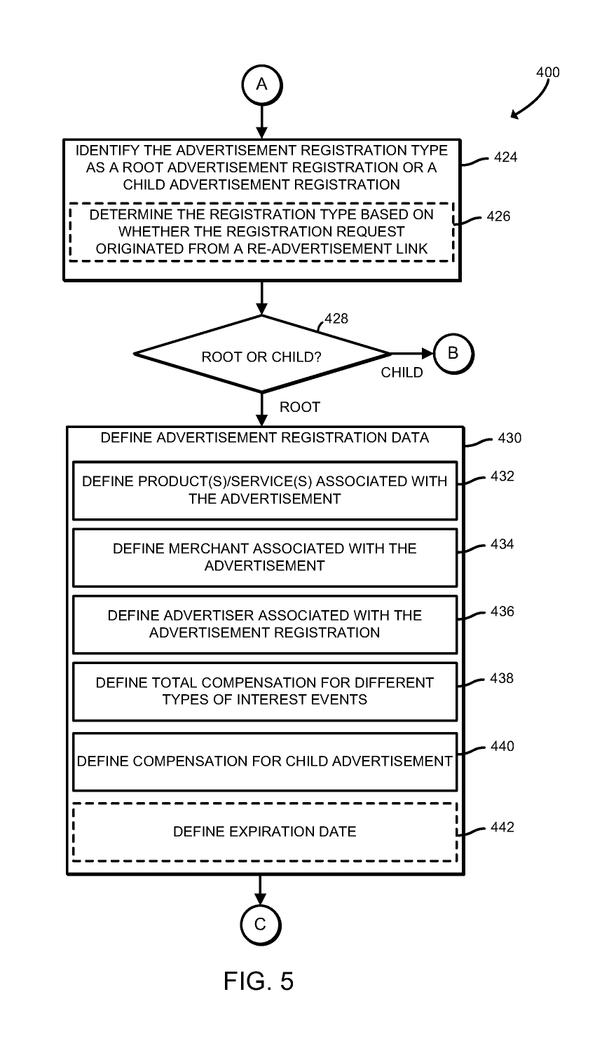

Subsequently, or if the advertisement management server 102 determines, in block 416, that the advertiser is already registered, the method 400 advances to block 424 of FIG. 5. In block 424, the advertisement management server 102 identifies the present advertisement registration type as a root advertisement registration or a child advertisement registration. In other words, if the advertiser is to originally post the advertisement, rather than re-posting the advertisement based on another posting of the advertisement by another advertiser, then the advertisement registration is for a root advertisement. Otherwise, the advertisement registration is for a child advertisement registration (i.e., the registration is to be a based on a previous registration of the advertisement to be re-posted by the present advertiser). In doing so, the advertisement management server 102 may determine the registration type based on whether the received registration request originated from a “re-advertisement” or “re-post” link or button associated with an existing posting of the advertisement, as indicated in block 426. For example, an advertiser may see an advertisement appearing in a posting made by an original advertiser on a website, such as the publisher server 106, and click a “re-post” link appearing in a corner of the advertisement. Upon clicking on the “re-post” link, the advertiser's compute device (e.g., advertiser compute device 110) may be directed to the advertisement management server 102 using a URL that includes a code that identifies the existing advertisement registration and specifies that the new registration type is to be a child of that advertisement registration. It is also possible that the existing registration is a child of an even earlier registration of the advertisement, and so on, such that a chain of advertisements having parent-child relationships may be formed.

In block 428, the advertisement management server 102 determines whether the advertisement registration type is a root advertisement registration or a child advertisement registration, based on the identification in block 424. If the advertisement registration is a root registration, the method 400 advances to block 430 in which the advertisement management server 102 defines (receives and stores, in the advertisement data 302) the advertisement registration data. In doing so, the illustrative advertisement management server 102 defines one or more products or services associated with the advertisement. For example, the advertisement management server 102 may receive a textual description, a reference to information regarding the one or more products or services (e.g., a URL to a web page of the merchant), or other information regarding the one or more products or services. Further, as indicated in block 434, the advertisement management server 102 may define the merchant associated with the advertisement. For example, the advertisement management server 102 may store a merchant identifier that uniquely identifies the merchant from other merchants in the merchant data 304 in association with the advertisement registration (i.e., in the advertisement data 302).

In addition, as indicated in block 436, the illustrative advertisement management server 102 defines the advertiser associated with the advertisement registration, such as by storing an advertiser identifier that uniquely identifies the advertiser. Additionally, the illustrative advertisement management server 102 defines the total compensation for different types of interest events, as indicated in block 438. The interest events may include a consumer viewing the advertisement, a consumer selecting (i.e., clicking on) the advertisement, a consumer purchasing the advertised product or service, or a person, such as an advertiser, re-posting the advertisement. As described above, when a subsequent advertiser re-posts an advertisement, the advertisement management server 102 registers the advertisement again (i.e., in association with that subsequent advertiser). In defining the total compensation, the advertisement management server 102 may define the amount and type of compensation for each interest event. The total compensation is the amount to be awarded by the merchant. As described in more detail herein, the total amount may be divided among numerous parties depending on the hierarchy of registrations associated with the advertisement, which registration the interest event is attributable to, and whether the advertisement management server 102 itself reserves a portion of the total amount as a fee for the operator or owner of the advertisement management server 102. The total amount illustratively embodied as a numeric value, while in other embodiments, it may be embodied in another form that indicates an amount of compensation. The type of compensation may be a specification of a currency, such as a national currency (e.g., U.S. dollars, Euros, yen, etc.), or a virtual currency, such as Bitcoin, or another form of compensation, such as points or discounts, that may be redeemable by the merchant or another party.

In block 440, the advertisement management server 102 defines compensation for a child advertisement. In doing so, the advertisement management server may specify a portion, which may be embodied as a relative amount, such as a percentage, or an absolute amount, such as a number of dollars, to be passed on to advertisers associated with child registrations of the advertisement, or may be defined in terms of the amount retained in association with the present registration, with the remainder to be assigned to advertiser(s) associated with any child registration(s). Additionally, in the illustrative embodiment, the advertisement management server 102 defines an expiration date for which the advertisement management server 102 is to no longer respond to interest events associated with the registration of the advertisement and/or when the advertisement management server 102 is to remove the registration from the advertisement data 302.

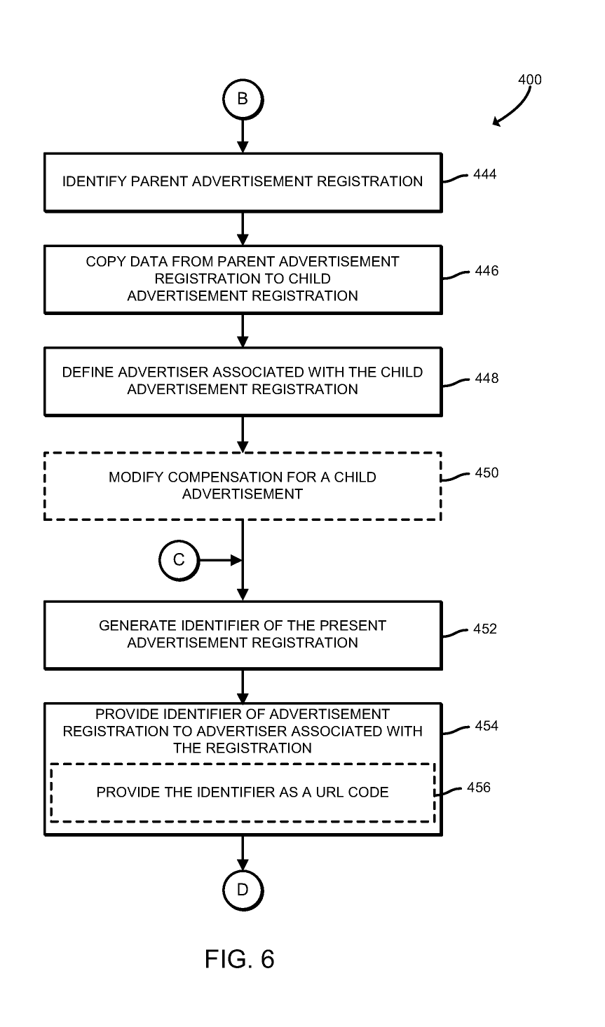

Referring back to block 428, if the advertisement management server 102 determines that the registration type is a child registration, the method 400 advances to block 444 of FIG. 6. In block 444, the advertisement management server 102 identifies the parent advertisement registration. As described herein, in the illustrative embodiment, the advertisement management server 102 may receive a code in a URL associated with a “re-post” link that includes an identification code of the parent advertisement registration. In other embodiments, the advertisement management server 102 may identify the parent advertisement registration using another method, such as by receiving an identifier of the parent advertisement from the advertiser (i.e., from one of the advertiser compute devices 110, 114) to be associated with the child advertisement. In block 446, the advertisement management server 102 copies data from the parent advertisement registration to the child advertisement registration. In the illustrative embodiment, the advertisement management server 102 copies the data described in block 432 through 442. In block 448, the advertisement management server 102 defines the advertiser associated with the child advertisement registration using a process similar to the process described in association with the block 436. In block 450, the advertisement management server 102 may modify the data regarding the compensation to be assigned to advertisers associated with child registrations of the present child registration. For example, the advertisement management server 102 may enable the present advertiser to increase or decrease the portion of the compensation to be passed on or retained by the present advertiser when an interest event occurs in association with a child registration of the present child registration.

Subsequent to block 442 of FIG. 5 or to block 450 of FIG. 6, the method 400 advances to block 452 in which the advertisement management server 102 generates an identifier of the present advertisement registration. The identifier may be embodied as any identifier, such as a code, that uniquely identifies the present advertisement registration in the advertisement data. In block 454, the advertisement management server 102 provides the identifier generated in block 454 to the advertiser associated with the present advertisement registration. In the illustrative embodiment, the advertisement management server 102 transmits the identifier to the advertiser compute device 110 or 114, associated with the advertiser. Further, in the illustrative embodiment, the advertisement management server 102 provides the identifier as a URL code (i.e., a code, such as an alphanumeric code, within a URL). Accordingly, the advertiser may specify the URL as the target web page for any selections (i.e., click-throughs) of the advertisement posted by the advertiser. The URL may specify an address of the advertisement management server 102 which may, in turn, redirect a compute device to the merchant server 104, such as to a URL specified in the product or service data for the advertisement registration, as described above with reference to block 432. Subsequently, the method 400 loops back to block 402 of FIG. 4, to monitor for another request to register an advertisement.

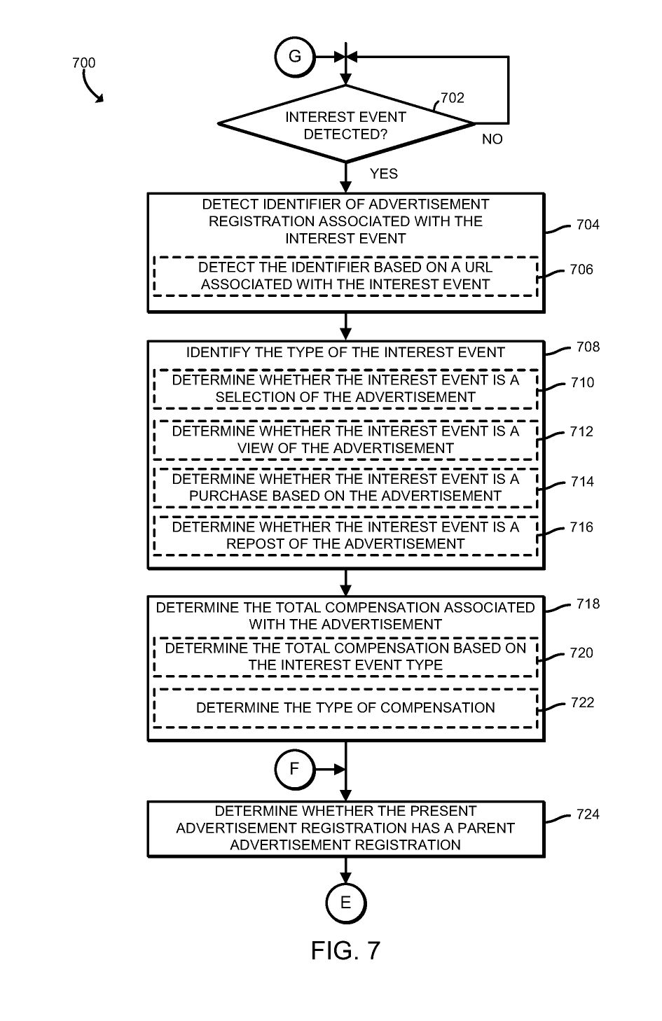

Referring now to FIG. 7, in use, the advertisement management server 102 may execute a method 700 for assigning compensation to advertisers in response to an interest event. The method 700 begins with block 702, in which the advertisement management server 102 determines whether an interest event has been detected. A view interest event may occur when a publisher server, such as the publisher server 106, requests an advertisement from the advertisement management server 102 to display in connection with other content, such as a blog posting, a social media page, or other content, and the advertisement management server 102 responds by transmitting the advertisement to the publisher server 106. As described above, an advertisement may include code, such as JavaScript, to cause a consumer compute device 112, 116 to report an amount of time that the advertisement was displayed to a user and the advertisement management server 102 may determine that an interest event has occurred only if the reported amount of time satisfies a predefined threshold amount of time (e.g., 5 seconds). The advertisement management server 102 may detect a selection interest event if a consumer clicks on or otherwise selects the advertisement, which initially directs the consumer's compute device 112 to the advertisement management server 102 using a URL that includes a code that identifies the advertisement registration, before the advertisement management server 102 redirects the consumer compute device 112 to another location, such as a website of the merchant server 104.

The advertisement management server 102 may detect a purchase interest event if the merchant or other party transmits a code to the advertisement management server 102 identifying the advertisement registration and indicating that a purchase has been made based on the advertisement. Further, the advertisement management server 102 may detect a re-posting or re-advertisement event when a compute device, such as the advertiser compute device 114, transmits an identifier of the advertisement registration with an indication that the advertiser wishes to re-post the advertisement (i.e., generate a child registration). As described above, this may occur if the advertiser clicks on a “re-post” or “re-advertise” link included in the advertisement and is subsequently directed to the advertisement management server 102. In other embodiments, the advertiser may contact the advertisement management server 102 without clicking on such a link. If the advertisement management server 102 determines that an interest event has occurred, the method 700 advances to block 704, in which the advertisement management server 102 detects an identifier of the advertisement registration associated with the interest event.

As described above, the identifier may be included in a URL to the advertisement management server 102 accessed by the consumer or advertiser, in association with the corresponding interest event, as indicated in block 706. Alternatively, the identifier may be reported by the merchant server 104 in association with a purchase event, or may otherwise be communicated to or determined by the advertisement management server 102 as described above. In block 708, the advertisement management server 102 identifies the type of interest event. In doing so, the advertisement management server 102 may determine whether the interest event is a selection of the advertisement, as indicated in block 710. As indicated in block 712, the advertisement management server 102 may determine whether the interest event is a view of the advertisement. Further, as indicated in block 714, the advertisement management server 102 may determine whether the interest event is a purchase based on the advertisement. Additionally, as indicated in block 716, the advertisement management server 102 may determine whether the interest even is a re-post of the advertisement. The ways in which the advertisement management server 102 may detect and determine the type of interest event are described above (i.e., based on the URL used to access the advertisement management server 102, based on the party generating the interest event, etc.).

In block 718, the advertisement management server 102 determines the total compensation associated with the advertisement. In doing so, the illustrative advertisement management server 102 accesses the advertisement data 302 associated with the identifier of the advertisement registration. As described above, the advertisement data 302 illustratively includes the total compensation for each interest event type and the type of compensation. Accordingly, the illustrative advertisement management server 102 determines the total compensation based on the interest event type, as indicated in block 720, and determines the type of compensation, as indicated in block 722, by reading the stored advertisement data 302. In block 724, the advertisement management server 102 determines whether the present advertisement registration has a parent advertisement registration. In the illustrative embodiment, the advertisement management server 102 reads a corresponding field in the advertisement data 302 associated with the identified advertisement registration. If the field is null or otherwise does not identify a parent advertisement registration, then the advertisement registration does not have a parent advertisement registration. Otherwise, the field illustratively includes an identifier of the parent advertisement registration.

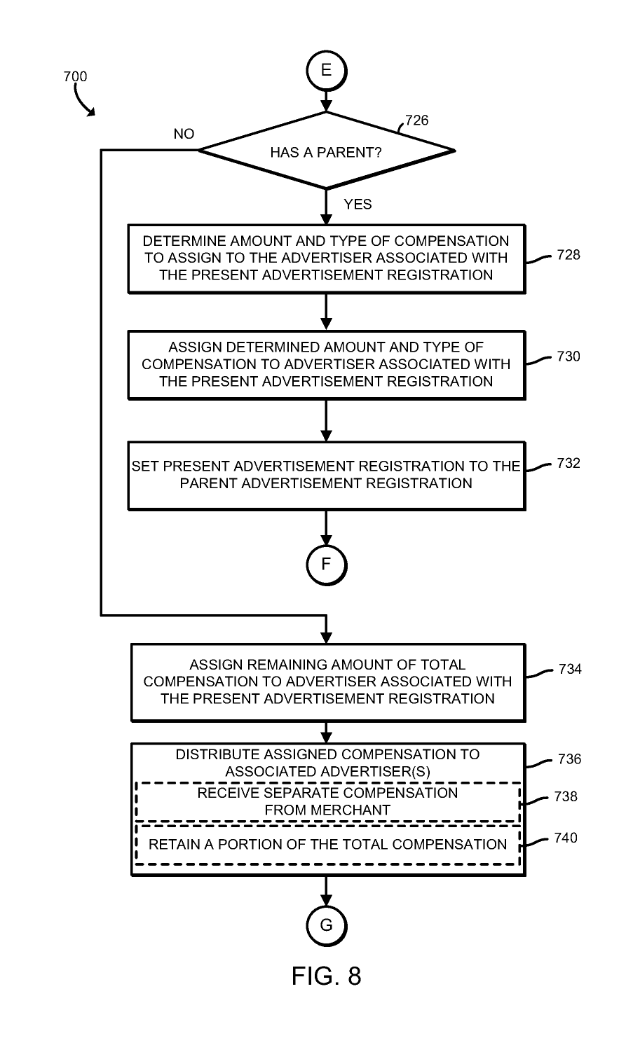

In block 726 of FIG. 8, the advertisement management server 102 determines whether the present advertisement registration has a parent, based on the analysis performed in block 724 of FIG. 7. If the present advertisement registration does have a parent, the method 700 advances to block 728. In block 728, the illustrative advertisement management server 102 determines the amount and type of compensation to assign to the advertiser associated with the present advertisement registration, by reading the corresponding fields from the advertisement data 302 for the advertisement registration. In block 730, the illustrative advertisement management server 102 assigns the amount and type of compensation to the advertiser associated with the present advertisement registration. In assigning the amount and type of compensation, the advertisement management server 102 may store these values in memory, to be later used in a compensation distribution process described herein. In block 732, the advertisement management server 102 sets the present advertisement registration to the parent advertisement registration identified in block 724 of FIG. 7. The method 700 subsequently loops back to block 724 to determine whether the present advertisement registration, that was set in block 732, has a parent.

Referring to block 726 of FIG. 8, if the advertisement management server 102 determines that the present advertisement registration does not have a parent, the method 700 advances to block 734 in which the advertisement management server 102 assigns the remaining amount of the total compensation to the advertiser associated with the present advertisement registration. Accordingly, if the advertisement registration that generated the interest event has no parent registrations, the total compensation is assigned only to the one advertiser associated with the advertisement registration. Otherwise, the advertisement management server 102 iteratively assigns portions of the compensation to each of the advertisers in the hierarchy or chain of advertisement registrations. In block 736, the advertisement management server 102 distributes the assigned compensation to the associated advertisers, such as by receiving the total amount of compensation from the merchant, using the merchant financial account data, and transmitting the determined compensation amounts to the advertisers to be compensated. As indicated in block 738, the advertisement management server 102 may receive separate compensation from the merchant as a fee for managing the advertisement propagation system 100. Alternatively, the advertisement management server 102 may retain a portion of the total compensation as such a fee. In yet other embodiments, the advertisement management server 102 does not charge a fee from the merchant.

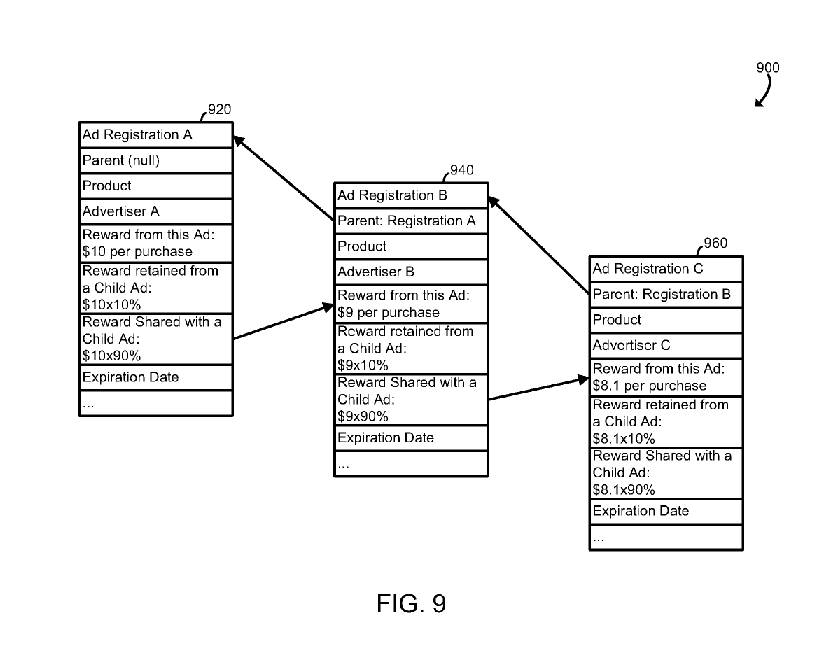

Referring now to FIG. 9, the advertisement management server 102 may store advertisement registrations in a hierarchy 900 in the advertisement data 302. A root advertisement registration 920 is a parent to another advertisement registration 940. The advertisement registration 940 is a parent to another advertisement registration 960. Each registration specifies that the advertiser associated with the registration is to retain 10% of the compensation and pass the other 90% to the child. Each registration defines an amount of compensation to be assigned to the advertiser associated with the advertisement registration for a given type of interest event, and also specifies compensation to be assigned to child advertisements. As shown, the advertiser directly associated with the advertisement registration that generated the interest event is to receive the majority of the compensation, while smaller amounts are assigned to the parents. Further, in the illustrative embodiment, an advertiser associated with a child advertisement registration does not receive any compensation when an interest event is generated from its parent advertisement registration.

As an example use of the system 100, one advertiser (“advertiser A”), using the advertiser compute device 110, transmits a request through the network 120 to the advertisement management server 102 to request registration of an advertisement. In doing so, the advertiser compute device 110 illustratively transmits the request using a communication subsystem, similar to the communication subsystem 208. The request may be formatted based on a communication protocol suitable for the network 120, such as an HTTP-formatted request. The advertisement management server 102 illustratively receives the request using the communication subsystem 208. Subsequently, the advertisement management server 102 and the advertiser compute device 110 communicate through the network 120 as described with reference to the method 400. In doing so, the advertisement management server 102 stores information about advertiser A in the advertiser data 306 and stores a record of the advertisement registration in the advertisement data 302. The advertiser data 306 and the advertisement data 302 are illustratively stored in the data storage 210 of the advertisement management server 102. Subsequently, the advertisement management server 102 transmits a URL to the advertiser compute device 110 through the network 120. The URL links any copies of the advertisement posted by advertiser A to the registration now stored in the advertisement data 302. Afterwards, the advertiser compute device 110 transmits the advertisement to the publisher server 108, such as in a blog posting, with code, such as HTML (hypertext markup language) code indicating that, when selected (i.e., clicked on) by a compute device, the compute device is to be directed to the URL that was provided by the advertisement management server 102, as described above.

Continuing the above example, another advertiser (“advertiser B”) views the posted advertisement. More specifically, the advertiser compute device 114 requests and receives the blog from the publisher server 108, using a communication subsystem similar to the communication subsystem 208, and renders the blog, including the advertisement, for viewing by advertiser B. Advertiser B subsequently determines to repost the advertisement to his own blog, hosted by the publisher server 106. In the example, the advertisement posted on publisher server 108 includes a “re-advertise” link that, when selected (e.g., clicked on) by the advertiser compute device 114, causes the advertiser compute device 114 to transmit a registration request to the advertisement management server 102, with an indicator of the registration that was generated above. The advertisement management server 102 and the advertiser compute device 114 communicate through the network 120 using their respective communication subsystems 208 to generate a second registration (i.e., a child registration) of the advertisement, pursuant to the method 400. The advertiser compute device 114 subsequently posts the advertisement with a second URL indicative of the second registration, to advertiser B's blog, hosted by the publisher server 106. Afterwards, a consumer, using the consumer compute device 116, selects the advertisement posted on the publisher server 106. In the example, in response to selecting the advertisement, the consumer compute device, using its communication subsystem, transmits a request through the network 120 to the advertisement management server 102, based on the second URL. The advertisement management server 102 receives the request, identifies the request as an interest event, and extracts an indicator of the second registration of the advertisement from the URL. The advertisement management server 102 then redirects the consumer compute device to the merchant server 104, to view additional information regarding a product described in the advertisement. Further, the advertisement management server 102 determines the appropriate amounts of compensation to be assigned to advertiser A and advertiser B, based on the registrations in the advertisement data, which define rules for apportioning compensation among advertisers associated with a registration (i.e., the owner of the registration that caused the interest event and the owners of any parent registrations). Additionally, the advertisement management server 102 transmits, through the network 120 using its communication subsystem 208, a notification to the advertiser compute devices 110, 114 of the compensation to be assigned to the respective advertisers in response to the detection of the interest event.

### EXAMPLES

Illustrative examples of the technologies disclosed herein are provided below. An embodiment of the technologies may include any one or more, and any combination of, the examples described below.

Example 1 includes an advertisement management server comprising a memory to store advertisement data; an advertisement data creation module to (i) generate a first registration of an advertisement in the advertisement data, wherein the first registration is associated with a first advertiser, and (ii) generate a second registration of the advertisement in the advertisement data, wherein the second registration is based on the first registration and is associated with a second advertiser that is different from the first advertiser; and a compensation manager module to (i) detect an interest event associated with the second registration of the advertisement, (ii) determine a first amount of compensation to assign to the first advertiser based on the interest event, and (iii) determine a second amount of compensation to assign to the second advertiser based on the interest event.

Example 2 includes the subject matter of Example 1, and wherein to generate the first registration comprises to define a total amount of compensation to be awarded based on the interest event; define a portion of the total amount of compensation to be awarded to the second advertiser based on the interest event.

Example 3 includes the subject matter of any of Examples 1 and 2, and wherein to generate the first registration comprises to define a total amount of compensation to be awarded for each of a plurality of different types of interest events.

Example 4 includes the subject matter of any of Examples 1-3, and wherein to define a total amount of compensation to be awarded for each of a plurality of different types of interest events comprises to define a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 5 includes the subject matter of any of Examples 1-4, and wherein to determine the first amount of compensation comprises to identify a type of the interest event; and determine the first amount of compensation based on the identified type of the interest event.

Example 6 includes the subject matter of any of Examples 1-5, and wherein to identify the type of the interest event comprises to identify the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 7 includes the subject matter of any of Examples 1-6, and wherein to generate the first registration comprises to generate a first identifier associated with the first registration; and provide the first identifier to the first advertiser to be used in association with the advertisement; and to generate the second registration comprises to generate a second identifier associated with the second registration; and provide the second identifier to the second advertiser to be used in association with the advertisement, wherein the second identifier is different than the first identifier.

Example 8 includes the subject matter of any of Examples 1-7, and wherein to provide the first identifier to the first advertiser comprises to provide a uniform resource locator (URL) that includes the first identifier to the first advertiser.

Example 9 includes the subject matter of any of Examples 1-8, and wherein to detect the interest event comprises to detect an identifier associated with the second registration in a uniform resource locator (URL) associated with the advertisement.

Example 10 includes the subject matter of any of Examples 1-9, and wherein the advertisement creation module is further to generate a third registration of the advertisement in the advertisement data, wherein the third registration is based on the second registration and is associated with a third advertiser that is different from the first advertiser and the second advertiser; and the compensation manager is further to determine that the third advertiser is not to receive compensation based on the interest event associated with the second registration.

Example 11 includes the subject matter of any of Examples 1-10, and wherein the advertisement data creation module is further to define a total amount of compensation to be awarded based on the interest event; and the compensation manager module is further to retain a portion of the total amount of compensation for an operator of the advertisement management server.

Example 12 includes the subject matter of any of Examples 1-11, and wherein the advertisement data creation module is further to register merchant financial account data of a merchant associated with the advertisement; and register advertiser financial account data for each of the first advertiser and the second advertiser; and the compensation manager module is further to distribute the first amount of compensation to the first advertiser and the second amount of compensation to the second advertiser based on the registered merchant financial account data and the advertiser financial account data.

Example 13 includes the subject matter of any of Examples 1-12, and wherein to determine the first amount of compensation to assign to the first advertiser based on the interest even comprises to determine an amount of compensation that is less than the second amount of compensation.

Example 14 includes the subject matter of any of Examples 1-13, and wherein the interest event is a first interest event, and the compensation manager is further to detect a second interest event associated with the first registration of the advertisement; and determine that the second advertiser is to be assigned less compensation than the first advertiser for the second interest event.

Example 15 includes a method comprising generating, by an advertisement management server, a first registration of an advertisement in advertisement data stored in a memory associated with the advertisement management server, wherein the first registration is associated with a first advertiser; generating, by the advertisement management server, a second registration of the advertisement in the advertisement data, wherein the second registration is based on the first registration and is associated with a second advertiser that is different from the first advertiser; detecting, by the advertisement management server, an interest event associated with the second registration of the advertisement; determining, by the advertisement management server, a first amount of compensation to assign to the first advertiser based on the interest event; and determining, by the advertisement management server, a second amount of compensation to assign to the second advertiser based on the interest event.

Example 16 includes the subject matter of Example 15, and wherein generating the first registration comprises defining a total amount of compensation to be awarded based on the interest event; and defining a portion of the total amount of compensation to be awarded to the second advertiser based on the interest event.

Example 17 includes the subject matter of any of Examples 15 and 16, and wherein generating the first registration comprises defining a total amount of compensation to be awarded for each of a plurality of different types of interest events.

Example 18 includes the subject matter of any of Examples 15-17, and wherein defining a total amount of compensation to be awarded for each of a plurality of different types of interest events comprises defining a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 19 includes the subject matter of any of Examples 15-18, and wherein determining the first amount of compensation comprises identifying a type of the interest event; and determining the first amount of compensation based on the identified type of the interest event.

Example 20 includes the subject matter of any of Examples 15-19, and wherein identifying the type of the interest event comprises identifying the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 21 includes the subject matter of any of Examples 15-20, and wherein generating the first registration comprises generating a first identifier associated with the first registration; and providing the first identifier to the first advertiser to be used in association with the advertisement; and generating the second registration comprises generating a second identifier associated with the second registration; and providing the second identifier to the second advertiser to be used in association with the advertisement, wherein the second identifier is different than the first identifier.

Example 22 includes the subject matter of any of Examples 15-21, and wherein providing the first identifier to the first advertiser comprises providing a uniform resource locator (URL) that includes the first identifier to the first advertiser.

Example 23 includes the subject matter of any of Examples 15-22, and wherein detecting the interest event comprises detecting an identifier associated with the second registration in a uniform resource locator (URL) associated with the advertisement.

Example 24 includes the subject matter of any of Examples 15-23, and further including generating, by the advertisement management server, a third registration of the advertisement in the advertisement data, wherein the third registration is based on the second registration and is associated with a third advertiser that is different from the first advertiser and the second advertiser; and determining, by the advertisement management server, that the third advertiser is not to receive compensation based on the interest event associated with the second registration.

Example 25 includes the subject matter of any of Examples 15-24, and further including defining, by the advertisement management server, a total amount of compensation to be awarded based on the interest event; and retaining, by the advertisement management server, a portion of the total amount of compensation for an operator of the advertisement management server.

Example 26 includes the subject matter of any of Examples 15-25, and further including registering, by the advertisement management server, merchant financial account data of a merchant associated with the advertisement; registering, by the advertisement management server, advertiser financial account data for each of the first advertiser and the second advertiser; and distributing, by the advertisement management server, the first amount of compensation to the first advertiser and the second amount of compensation to the second advertiser based on the registered merchant financial account data and the advertiser financial account data.

Example 27 includes the subject matter of any of Examples 15-26, and wherein determining the first amount of compensation to assign to the first advertiser based on the interest even comprises determining an amount of compensation that is less than the second amount of compensation.

Example 28 includes the subject matter of any of Examples 15-27, and wherein the interest event is a first interest event, the method further comprising detecting a second interest event associated with the first registration of the advertisement; and determining that the second advertiser is to be assigned less compensation than the first advertiser for the second interest event.

Example 29 includes one or more computer-readable storage media comprising a plurality of instructions that, when executed, cause a compute device to perform the method of any of Examples 15-28.

Example 30 includes an advertisement management server comprising means for generating a first registration of an advertisement in advertisement data stored in a memory associated with the advertisement management server, wherein the first registration is associated with a first advertiser; means for generating a second registration of the advertisement in the advertisement data, wherein the second registration is based on the first registration and is associated with a second advertiser that is different from the first advertiser; means for detecting an interest event associated with the second registration of the advertisement; means for determining a first amount of compensation to assign to the first advertiser based on the interest event; and means for determining a second amount of compensation to assign to the second advertiser based on the interest event.

Example 31 includes the subject matter of Example 30, and wherein the means for generating the first registration comprises means for defining a total amount of compensation to be awarded based on the interest event; and means for defining a portion of the total amount of compensation to be awarded to the second advertiser based on the interest event.

Example 32 includes the subject matter of any of Examples 30 and 31, and wherein the means for generating the first registration comprises means for defining a total amount of compensation to be awarded for each of a plurality of different types of interest events.

Example 33 includes the subject matter of any of Examples 30-32, and wherein the means for defining a total amount of compensation to be awarded for each of a plurality of different types of interest events comprises means for defining a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 34 includes the subject matter of any of Examples 30-33, and wherein the means for determining the first amount of compensation comprises means for identifying a type of the interest event; and means for determining the first amount of compensation based on the identified type of the interest event.

Example 35 includes the subject matter of any of Examples 30-34, and wherein the means for identifying the type of the interest event comprises means for identifying the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 36 includes the subject matter of any of Examples 30-35, and wherein the means for generating the first registration comprises means for generating a first identifier associated with the first registration; and means for providing the first identifier to the first advertiser to be used in association with the advertisement; and generating the second registration comprises means for generating a second identifier associated with the second registration; and means for providing the second identifier to the second advertiser to be used in association with the advertisement, wherein the second identifier is different than the first identifier.

Example 37 includes the subject matter of any of Examples 30-36, and wherein the means for providing the first identifier to the first advertiser comprises means for providing a uniform resource locator (URL) that includes the first identifier to the first advertiser.

Example 38 includes the subject matter of any of Examples 30-37, and wherein the means for detecting the interest event comprises means for detecting an identifier associated with the second registration in a uniform resource locator (URL) associated with the advertisement.

Example 39 includes the subject matter of any of Examples 30-38, and further including means for generating a third registration of the advertisement in the advertisement data, wherein the third registration is based on the second registration and is associated with a third advertiser that is different from the first advertiser and the second advertiser; and means for determining that the third advertiser is not to receive compensation based on the interest event associated with the second registration.

Example 40 includes the subject matter of any of Examples 30-39, and further including means for defining a total amount of compensation to be awarded based on the interest event; and means for retaining a portion of the total amount of compensation for an operator of the advertisement management server.

Example 41 includes the subject matter of any of Examples 30-40, and further including means for registering merchant financial account data of a merchant associated with the advertisement; means for registering advertiser financial account data for each of the first advertiser and the second advertiser; and means for distributing the first amount of compensation to the first advertiser and the second amount of compensation to the second advertiser based on the registered merchant financial account data and the advertiser financial account data.

Example 42 includes the subject matter of any of Examples 30-41, and wherein the means for determining the first amount of compensation to assign to the first advertiser based on the interest even comprises means for determining an amount of compensation that is less than the second amount of compensation.

Example 43 includes the subject matter of any of Examples 30-42, and wherein the interest event is a first interest event, the advertisement management server further comprising means for detecting a second interest event associated with the first registration of the advertisement; and means for determining that the second advertiser is to be assigned less compensation than the first advertiser for the second interest event.

Example 44 includes an advertisement management server to communicate with at least a consumer compute device, a first advertiser compute device, and a second advertiser compute device through a network, said advertisement management server comprising a memory to store advertisement data; an advertisement data creation module to (i) generate a first registration of an advertisement in the advertisement data in response to a first request received from the first advertiser compute device through the network, wherein the first registration is associated with a first advertiser, and (ii) generate a second registration of the advertisement in the advertisement data in response to a second request received from the second advertiser compute device through the network, wherein the second registration is based on the first registration and is associated with a second advertiser that is different from the first advertiser; and a compensation manager module to (i) detect an interest event associated with the second registration of the advertisement based on a communication transmitted from the consumer compute device through the network, (ii) determine a first amount of compensation to assign to the first advertiser based on the interest event, (iii) determine a second amount of compensation to assign to the second advertiser based on the interest event, and (iv) provide an indication of the first amount of compensation to the first advertiser and the second amount of compensation to the second advertiser through the network.

Example 45 includes the subject matter of Example 44, and wherein to generate the first registration comprises to define a total amount of compensation to be awarded based on the interest event; define a portion of the total amount of compensation to be awarded to the second advertiser based on the interest event.

Example 46 includes the subject matter of Examples 44 and 45, and wherein to generate the first registration comprises to define a total amount of compensation to be awarded for each of a plurality of different types of interest events.

Example 47 includes the subject matter of Examples 44-46, and wherein to define a total amount of compensation to be awarded for each of a plurality of different types of interest events comprises to define a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 48 includes the subject matter of Examples 44-47, and wherein to determine the first amount of compensation comprises to identify a type of the interest event; and determine the first amount of compensation based on the identified type of the interest event.

Example 49 includes the subject matter of Examples 44-48, and wherein to identify the type of the interest event comprises to identify the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 50 includes the subject matter of Examples 44-49, and wherein to generate the first registration comprises to generate a first identifier associated with the first registration; and provide the first identifier to the first advertiser compute device to be used in association with the advertisement; and to generate the second registration comprises to generate a second identifier associated with the second registration; and provide the second identifier to the second advertiser compute device to be used in association with the advertisement, wherein the second identifier is different than the first identifier.

Example 51 includes the subject matter of Examples 44-50, and wherein to provide the first identifier to the first advertiser compute device comprises to provide a uniform resource locator (URL) that includes the first identifier to the first advertiser compute device.

Example 52 includes the subject matter of Examples 44-51, and wherein to detect the interest event comprises to detect an identifier associated with the second registration in a uniform resource locator (URL) associated with the advertisement.

Example 53 includes one or more computer-readable storage media comprising a plurality of instructions that, when executed by an advertisement management server to communicate with at least a consumer compute device, a first advertiser compute device, and a second advertiser compute device through a network, cause the advertisement management server to generate a first registration of an advertisement in advertisement data stored in a memory associated with the advertisement management server in response to a first request received from the first advertiser compute device through the network, wherein the first registration is associated with a first advertiser; generate a second registration of the advertisement in the advertisement data in response to a second request received from the second advertiser compute device through the network, wherein the second registration is based on the first registration and is associated with a second advertiser that is different from the first advertiser; detect an interest event associated with the second registration of the advertisement based on a communication transmitted from the consumer compute device through the network; determine a first amount of compensation to assign to the first advertiser based on the interest event; determine a second amount of compensation to assign to the second advertiser based on the interest event; and provide an indication of the first amount of compensation to the first advertiser and the second amount of compensation to the second advertiser through the network.

Example 54 includes the subject matter of Example 53, and wherein to generate the first registration comprises to define a total amount of compensation to be awarded based on the interest event; and to define a portion of the total amount of compensation to be awarded to the second advertiser based on the interest event.

Example 55 includes the subject matter of Examples 53 and 54, and wherein to generate the first registration comprises to define a total amount of compensation to be awarded for each of a plurality of different types of interest events.

Example 56 includes the subject matter of Examples 53-55, and wherein to define a total amount of compensation to be awarded for each of a plurality of different types of interest events comprises to define a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 57 includes the subject matter of Examples 53-56, and wherein to determine the first amount of compensation comprises to identify a type of the interest event; and to determine the first amount of compensation based on the identified type of the interest event.

Example 58 includes the subject matter of Examples 53-57, and wherein to identify the type of the interest event comprises to identify the type of the interest event as one of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 59 includes the subject matter of Examples 53-58, and wherein to generate the first registration comprises to generate a first identifier associated with the first registration; and to provide the first identifier to the first advertiser compute device to be used in association with the advertisement; and to generate the second registration comprises to generate a second identifier associated with the second registration; and to provide the second identifier to the second advertiser compute device to be used in association with the advertisement, wherein the second identifier is different than the first identifier.

Example 60 includes the subject matter of Examples 53-59, and wherein to generate the first registration comprises to define a total amount of compensation to be awarded for each of a plurality of different types of interest events.

Example 61 includes a method comprising generating, by an advertisement management server in communication with at least a consumer compute device, a first advertiser compute device, and a second advertiser compute device through a network, a first registration of an advertisement in advertisement data stored in a memory associated with the advertisement management server, in response to a first request received from the first advertiser compute device through the network, wherein the first registration is associated with a first advertiser; generating, by the advertisement management server, a second registration of the advertisement in the advertisement data in response to a second request received from the second advertiser compute device through the network, wherein the second registration is based on the first registration and is associated with a second advertiser that is different from the first advertiser; detecting, by the advertisement management server, an interest event associated with the second registration of the advertisement based on a communication transmitted from the consumer compute device through the network; determining, by the advertisement management server, a first amount of compensation to assign to the first advertiser based on the interest event; determining, by the advertisement management server, a second amount of compensation to assign to the second advertiser based on the interest event; and providing, by the advertisement management server, an indication of the first amount of compensation to the first advertiser and the second amount of compensation to the second advertiser through the network.

Example 62 includes the subject matter of Example 61, and wherein generating the first registration comprises defining a total amount of compensation to be awarded based on the interest event; and defining a portion of the total amount of compensation to be awarded to the second advertiser based on the interest event.

Example 63 includes the subject matter of Examples 61 and 62, and wherein generating the first registration comprises defining a total amount of compensation to be awarded for each of a plurality of different types of interest events.

Example 64 includes the subject matter of Examples 61-63, and wherein defining a total amount of compensation to be awarded for each of a plurality of different types of interest events comprises defining a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 65 includes the subject matter of Examples 61-64, and wherein determining the first amount of compensation comprises identifying a type of the interest event; and determining the first amount of compensation based on the identified type of the interest event.

Example 66 includes the subject matter of Examples 61-65, and wherein identifying the type of the interest event comprises identifying the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

Example 67 includes the subject matter of Examples 61-66, and wherein generating the first registration comprises generating a first identifier associated with the first registration; and providing the first identifier to the first advertiser compute device to be used in association with the advertisement; and generating the second registration comprises generating a second identifier associated with the second registration; and providing the second identifier to the second advertiser compute device to be used in association with the advertisement, wherein the second identifier is different than the first identifier.

Example 68 includes the subject matter of Examples 61-67, and wherein providing the first identifier to the first advertiser compute device comprises providing a uniform resource locator (URL) that includes the first identifier to the first advertiser compute device.

1-25. (canceled)

26. An advertisement management server to communicate with at least a consumer compute device, a first advertiser compute device, and a second advertiser compute device through a network, said advertisement management server comprising:
a memory to store advertisement data;
an advertisement data creation module to (i) generate a first registration of an advertisement in the advertisement data in response to a first request received from the first advertiser compute device through the network, wherein the first registration is associated with a first advertiser, and (ii) generate a second registration of the advertisement in the advertisement data in response to a second request received from the second advertiser compute device through the network, wherein the second registration is based on the first registration and is associated with a second advertiser that is different from the first advertiser; and
a compensation manager module to (i) detect an interest event associated with the second registration of the advertisement based on a communication transmitted from the consumer compute device through the network, (ii) determine a first amount of compensation to assign to the first advertiser based on the interest event, (iii) determine a second amount of compensation to assign to the second advertiser based on the interest event, and (iv) provide an indication of the first amount of compensation to the first advertiser and the second amount of compensation to the second advertiser through the network.

27. The advertisement management server of claim 26, wherein to generate the first registration comprises to:
define a total amount of compensation to be awarded based on the interest event;
define a portion of the total amount of compensation to be awarded to the second advertiser based on the interest event.

28. The advertisement management server of claim 26, wherein to generate the first registration comprises to define a total amount of compensation to be awarded for each of a plurality of different types of interest events.

29. The advertisement management server of claim 28, wherein to define a total amount of compensation to be awarded for each of a plurality of different types of interest events comprises to define a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

30. The advertisement management server of claim 26, wherein to determine the first amount of compensation comprises to:
identify a type of the interest event; and
determine the first amount of compensation based on the identified type of the interest event.

31. The advertisement management server of claim 30, wherein to identify the type of the interest event comprises to identify the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

32. The advertisement management server of claim 26, wherein:
to generate the first registration comprises to:
generate a first identifier associated with the first registration; and
provide the first identifier to the first advertiser compute device to be used in association with the advertisement; and
to generate the second registration comprises to:
generate a second identifier associated with the second registration; and
provide the second identifier to the second advertiser compute device to be used in association with the advertisement, wherein the second identifier is different than the first identifier.

33. The advertisement management server of claim 32, wherein to provide the first identifier to the first advertiser compute device comprises to provide a uniform resource locator (URL) that includes the first identifier to the first advertiser compute device.

34. The advertisement management server of claim 26, wherein to detect the interest event comprises to detect an identifier associated with the second registration in a uniform resource locator (URL) associated with the advertisement.

35. One or more computer-readable storage media comprising a plurality of instructions that, when executed by an advertisement management server to communicate with at least a consumer compute device, a first advertiser compute device, and a second advertiser compute device through a network, cause the advertisement management server to:
generate a first registration of an advertisement in advertisement data stored in a memory associated with the advertisement management server in response to a first request received from the first advertiser compute device through the network, wherein the first registration is associated with a first advertiser;
generate a second registration of the advertisement in the advertisement data in response to a second request received from the second advertiser compute device through the network, wherein the second registration is based on the first registration and is associated with a second advertiser that is different from the first advertiser;
detect an interest event associated with the second registration of the advertisement based on a communication transmitted from the consumer compute device through the network;
determine a first amount of compensation to assign to the first advertiser based on the interest event;
determine a second amount of compensation to assign to the second advertiser based on the interest event; and
provide an indication of the first amount of compensation to the first advertiser and the second amount of compensation to the second advertiser through the network.

36. The one or more computer-readable storage media of claim 35, wherein to generate the first registration comprises:
to define a total amount of compensation to be awarded based on the interest event; and
to define a portion of the total amount of compensation to be awarded to the second advertiser based on the interest event.

37. The one or more computer-readable storage media of claim 35, wherein to generate the first registration comprises to define a total amount of compensation to be awarded for each of a plurality of different types of interest events.

38. The one or more computer-readable storage media of claim 37, wherein to define a total amount of compensation to be awarded for each of a plurality of different types of interest events comprises to define a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

39. The one or more computer-readable storage media of 35, wherein to determine the first amount of compensation comprises:
to identify a type of the interest event; and
to determine the first amount of compensation based on the identified type of the interest event.

40. The one or more computer-readable storage media of 39, wherein to identify the type of the interest event comprises to identify the type of the interest event as one of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

41. The one or more computer-readable storage media of 35, wherein:
to generate the first registration comprises:
to generate a first identifier associated with the first registration; and
to provide the first identifier to the first advertiser compute device to be used in association with the advertisement; and
to generate the second registration comprises:
to generate a second identifier associated with the second registration; and
to provide the second identifier to the second advertiser compute device to be used in association with the advertisement, wherein the second identifier is different than the first identifier.

42. The one or more computer-readable storage media of claim 40, wherein to generate the first registration comprises to define a total amount of compensation to be awarded for each of a plurality of different types of interest events.

43. A method comprising:
generating, by an advertisement management server in communication with at least a consumer compute device, a first advertiser compute device, and a second advertiser compute device through a network, a first registration of an advertisement in advertisement data stored in a memory associated with the advertisement management server, in response to a first request received from the first advertiser compute device through the network, wherein the first registration is associated with a first advertiser;
generating, by the advertisement management server, a second registration of the advertisement in the advertisement data in response to a second request received from the second advertiser compute device through the network, wherein the second registration is based on the first registration and is associated with a second advertiser that is different from the first advertiser;
detecting, by the advertisement management server, an interest event associated with the second registration of the advertisement based on a communication transmitted from the consumer compute device through the network;
determining, by the advertisement management server, a first amount of compensation to assign to the first advertiser based on the interest event;
determining, by the advertisement management server, a second amount of compensation to assign to the second advertiser based on the interest event; and
providing, by the advertisement management server, an indication of the first amount of compensation to the first advertiser and the second amount of compensation to the second advertiser through the network.

44. The method of claim 43, wherein generating the first registration comprises:
defining a total amount of compensation to be awarded based on the interest event; and
defining a portion of the total amount of compensation to be awarded to the second advertiser based on the interest event.

45. The method of claim 43, wherein generating the first registration comprises defining a total amount of compensation to be awarded for each of a plurality of different types of interest events.

46. The method of claim 45, wherein defining a total amount of compensation to be awarded for each of a plurality of different types of interest events comprises defining a different total amount of compensation for each of an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

47. The method of claim 43, wherein determining the first amount of compensation comprises:
identifying a type of the interest event; and
determining the first amount of compensation based on the identified type of the interest event.

48. The method of claim 47, wherein identifying the type of the interest event comprises identifying the type of the interest event as one an advertisement view event indicative of when a consumer views the advertisement, an advertisement selection event indicative of when a consumer selects the advertisement, an advertisement re-post event indicative of when a subsequent advertisement registration is generated based on the advertisement, and a purchase event indicative of when a consumer makes a purchase based on the advertisement.

49. The method of claim 43, wherein:
generating the first registration comprises:
generating a first identifier associated with the first registration; and
providing the first identifier to the first advertiser compute device to be used in association with the advertisement; and
generating the second registration comprises:
generating a second identifier associated with the second registration; and
providing the second identifier to the second advertiser compute device to be used in association with the advertisement, wherein the second identifier is different than the first identifier.

50. The method of claim 49, wherein providing the first identifier to the first advertiser compute device comprises providing a uniform resource locator (URL) that includes the first identifier to the first advertiser compute device.
